(19) United States
(12) Patent Application Publication
(10) Pub. No.: US 2026/0310761 A1
(43) Pub. Date: Oct. 8, 2026

(54) SYSTEM AND METHOD FOR SMART LICENSE AUTOMATIC DETACH BY CLOUD LICENSE MANAGER SERVICE

(71) Applicant: THALES DIS CPL USA, INC., Austin, TX (US)

(72) Inventors: Peter YuBao CHENG, Beijing (CN); Wendong LIN, Beijing (CN); Donghua WANG, Beijing (CN)

(73) Assignee: THALES DIS CPL USA, INC., Austin, TX (US)

(21) Appl. No.: 19/482,278

(22) PCT Filed: May 14, 2024
(86) PCT No.: PCT/US2024/029256

§ 371 Date: Nov. 7, 2025

(30) Foreign Application Priority Data
May 16, 2023 (CN) 202310547743.X

(51) Int. Cl. G06F 21/10

(52) U.S. Cl. CPC G06F 21/105; G06F 21/107

(57) ABSTRACT

A system or method of smart license automatic detach by a cloud license manager service includes one or more processors executing computer instructions that perform operations including a cloud license manager service operating at a server where a database stores one or more cloud licenses for one or more corresponding clients, a licensing application programming interface (API) configured to access a license locally or online from the cloud license manager service, and providing an automatic license detach executed by a login API and controlled by the cloud license manager service. The method can further include operations of providing a licensed application on the client-side that integrates with the licensing API to validate a license for the licensed application and exiting the licensed application if the license is unavailable or expired based on one or more policies. The system and method improves the availability of both services and a license application.

### CROSS-REFERENCE TO RELATED APPLICATIONS

Not applicable.

### TECHNICAL FIELD

The present disclosure generally relates to license detach policies, and more particularly to a system and method for smart license automatic detach by a cloud license manager server to improve the availability of both services and a licensed application.

### BACKGROUND

Generally, API rate limiting (throttling and quotas) can be used to help protect service from being overwhelmed by too many requests. Rate limiting on both server-side and client-side is extremely important for maximizing reliability and minimizing latency, and the larger the systems/APIs, the more crucial rate limiting will be.

However, the common API rate limiting methods, requests will be allowed as long as they remain below the threshold. Once the number of requests meets the threshold, the request will be blocked.

Traditional license automatic detach logic is when you log into the Cloud License which is managed by Cloud License Manager Service, you will get one detached local license and then you can use it in offline with a short expiration date like 2 hours or 1 day. At the same time, once it is detached, it can reduce the workload of the Cloud License Manager Service because it has less requests during this short expiration duration.

US Patent Publication No. 20210234890 published on Jul. 29, 2021 to assignee Salesforce. com, Inc. entitled “Predictive rate limiting system for cloud computing services” discloses a method of predictive rate limiting for performing services requested by a client in a cloud computing system. The method includes receiving a request from a client for one of a plurality of services to be performed, the client belonging to an organization; and determining a current threshold for the organization by applying a real time data model and a historical data model, the real time data model generating a first threshold at least in part by determining a number of requests received from the organization over a first preceding period of time; the historical data model generating a second threshold, the historical data model being generated by applying a machine learning model to historical data stored during processing of previous requests for the plurality of services from the organization over a second preceding period of time, the current threshold being the average of the first threshold and the second threshold. The method further includes performing the requested service when the current threshold is not exceeded; and denying the request when the current threshold is exceeded. Such system fails to efficiently use a smart license automatic detach scheme that incorporate policies enabling improved availability of both services and licensed applications.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### SUMMARY

In some embodiments, a system of smart license automatic detach by a cloud license manager service can include one or more processors and memory coupled to the one or more processors, where the memory includes computer instructions which when executed by the one or more processors causes the one or more processors to perform certain operations. The operations can include a cloud license manager service operating at a server on a server-side, wherein a database stores one or more cloud licenses for one or more corresponding clients, a licensing application programming interface (API) on a client-side configured to access a license locally from the client-side or online from the cloud license manager service, and providing an automatic license detach executed by a login API and controlled by the cloud license manager service. The method can further include operations of providing a licensed application on the client-side that integrates with the licensing API to validate a license for the licensed application and exiting the licensed application if the license is unavailable or expired based on one or more policies stored at the server.

In some embodiments, the API set includes a login API and one or more among APIs for encryption, decryption, read, write, or logout.

In some embodiments, the smart license automatic detach further provides a license detach based on workload and historical data available to the cloud license manager service.

In some embodiments, the cloud license manager service adopts a policy of performing license automatic detach for all new login requests according to a total workload of service exceeding a pre-defined throttling value. In some embodiments, if a new login request exceeds a configurable value such as 80% or other predetermined throttling value, the new login request will trigger a license auto detach for the new login request.

In some embodiments, the cloud license manager service adopts the policy of performing license automatic detach for dedicated busy clients, if a cloud license manager service workload exceeds a predefined throttling value for a dedicated busy client. In some embodiments, if the cloud license manager service workload exceeds the predefined throttling value, the cloud license manager service sends the dedicated busy client a denial of service message and a dedicated error coded that is configured to grant the client access to a local detached license upon a retry.

In some embodiments, the cloud license manager service adopts a policy of pre-generating a detached license for a predicted peak time for pre-determined clients according to historical data. In some embodiments, the pre-generated detached license is generated in advance during an idle time for the pre-determined clients with a fixed busy time usage window.

In some embodiments, in order to perform the license detach, the cloud license manager service adopts the policies of one or more of (a) performing license automatic detach for all new login requests according to a total workload of service exceeding a pre-defined throttling value; (b) performing license automatic detach for dedicated busy clients, if a cloud license manager service workload exceeds a predefined throttling value for a dedicated busy client; or (c) pre-generating a detached license for a predicted peak time for pre-determined clients according to historical data.

In some embodiments, the cloud manager service is further configured to actively synchronize a client failing to meet the policies (a), (b), or (c) with an increased random time jitter heart beat duration as an increasing workload at the server is determined to reduce client requests.

In some embodiments, a system of smart license automatic detach by a cloud license manager service can include one or more processors and memory coupled to the one or more processors, where the memory includes computer instructions which when executed by the one or more processors causes the one or more processors at the one or more servers to perform certain operations. Such operations can include a cloud license manager service operating at a server on a server-side, wherein a database stores one or more cloud licenses for one or more corresponding clients, interfacing with a licensing application programming interface (API) on a client-side configured to enable access of a license from the client-side or online from the cloud license manager service, and controlling an automatic license detach by the cloud license manager service using a login API. The operations can further include enabling a licensed application on the client-side that integrates with the licensing API to validate a license for the licensed application, and exiting the licensed application if the license is unavailable or expired based on one or more policies stored at the server.

In some embodiments, the one or more servers on the server-side is further configured to monitor a workload from a plurality of clients based on a throughput value of requests to the one or more servers.

In some embodiments, the smart license automatic detach further provides a license detach based on workload and historical data available to the cloud license manager service.

In some embodiments, the cloud license manager service adopts a policy of performing license automatic detach for all new login requests according to a total workload of service exceeding a pre-defined throttling value.

In some embodiments, the cloud license manager service adopts the policy of performing license automatic detach for dedicated busy clients, if a cloud license manager service workload exceeds a predefined throttling value for a dedicated busy client.

In some embodiments, the cloud license manager service adopts a policy of pre-generating a detached license for a predicted peak time for pre-determined clients according to historical data.

In some embodiments, the in order to perform the license detach, the cloud license manager service adopts the policies of one or more of (a) performing license automatic detach for all new login requests according to a total workload of service exceeding a pre-defined throttling value (b) performing license automatic detach for dedicated busy clients, if a cloud license manager service workload exceeds a predefined throttling value for a dedicated busy client, and (c) pre-generating a detached license for a predicted peak time for pre-determined clients according to historical data.

In some embodiments, the cloud manager service is further configured to actively synchronize a client failing to meet the policies (a), (b), or (c) with an increased random time jitter heart beat duration as an increasing workload at the server is determined to reduce client requests.

In some embodiments, the a method of smart license automatic detach by a cloud license manager service can include the operations of operating a cloud license manager service at a server on a server-side, storing in a database on the sever-side one or more cloud licenses for one or more corresponding clients, interfacing with a licensing application programming interface (API) on a client-side configured to enable access to a license from the client-side or online from the cloud license manager service, and controlling an automatic license detach by the cloud license manager service using a login API. In some embodiments, the method further includes enabling a licensed application on the client-side that integrates with the licensing API to validate a license for the licensed application and exiting the licensed application if the license is unavailable or expired based on one or more policies stored at the server.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 illustrates a system and method of smart license automatic detach by a cloud license manager service in accordance with the embodiments;

FIG. 2 illustrates another system and method of smart license automatic detach by a cloud license manager service in accordance with the embodiments;

FIG. 3 illustrates a flow chart of a method of smart license automatic detach by a cloud license manager service in accordance with the embodiments;

FIG. 4 illustrates a flow chart of a method of smart license automatic detach by a cloud license manager service using policies in accordance with the embodiments;

FIG. 5 illustrates an a computing system in accordance with some embodiments;

FIG. 6 illustrates an example of a storage medium in accordance with some embodiments;

FIG. 7 illustrates another example computing platform.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

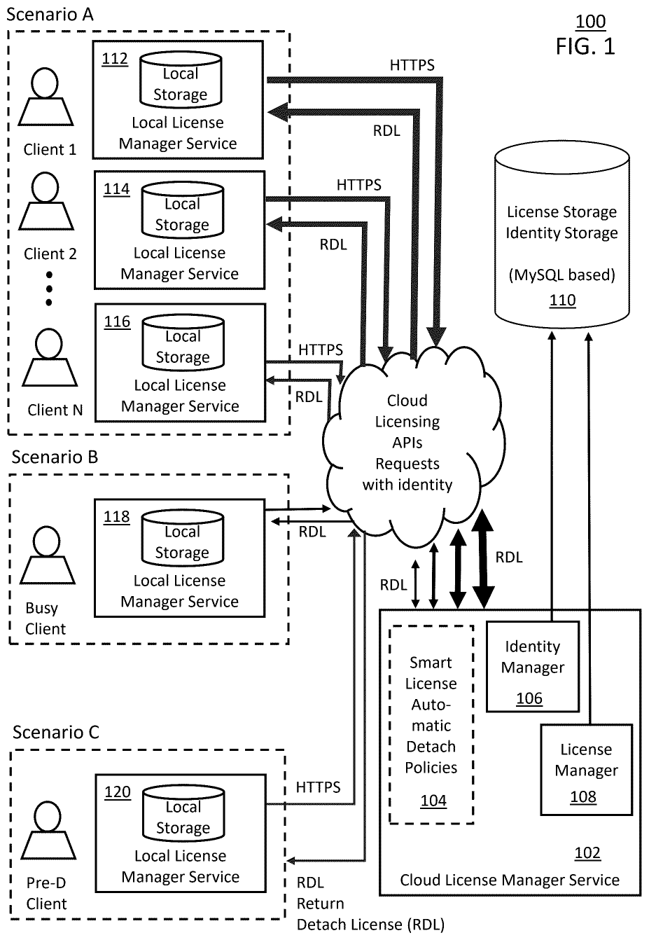

Referring to a system 100 in FIG. 1, a method and system supports a smart license automatic detach by a cloud license manager service 102 on a server-side to improve the availability of both the services and the license application. Although rate limiting is generally put in place as a defensive measure for services, the embodiments further strive to provide a good user experience and performance for a licensed application. The system 100 can include one or more cloud licenses stored in a database 110 which can be a license storage and identity storage that is MySQL based for example. The database 110 can be coupled to an identity manager 106 and a license manager 108 of the cloud license manager service 102. The cloud license manager service 102 can further include a plurality of smart license automatic detach policies 104 which would return a detach license upon an appropriate request meeting the requirements of the one or more policies 104.

The system 100 can further include a licensing application programming interface (API) 122 on a client-side. The API 122 can access the license locally (on the client side) or online from the cloud license manager service 102. The API 122 can have a set that includes APIs such as login, encryption, decryption, read, write, and/or logout. The API 122 can also provide a credentialing or identity function enabling access to a public cloud license manager where each client would be assigned with a unique credential that can be an API key. Any license detach can be handled by a login API internally (to the API), and can be further controlled by the cloud license manager service 102. A licensed application can reside on the client-side within a local storage at a local license manager service (112, 114, 116, 118, or 120). The licensed application can integrate with a licensing API to check for a valid license either used locally or as a cloud license. If a license is not available or expired, then the licensed application will be forced to exit. The system 100 for smart license automatic detach will enable the cloud license manager service 102 to decide when and how to perform a licensed detached based on workload and historical data during various instances and unlike traditional license automatic detach that is only triggered upon license login requests by a client.

More particularly, the system 100 will use the smart license automatic detach policies 104 to intelligently make decisions when and how to perform the license detach.

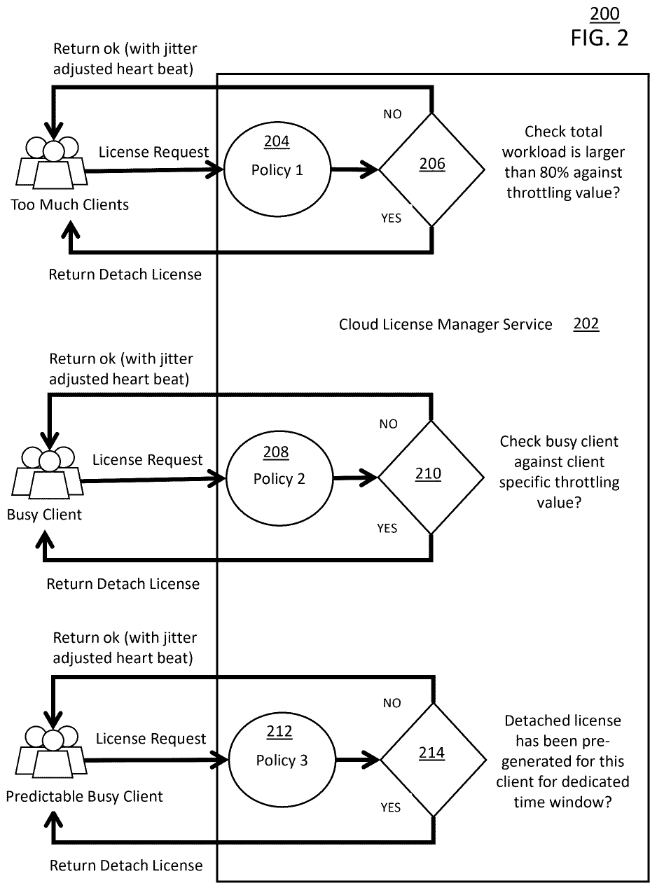

Referring to FIG. 2, a system 200 similar to the system 100 can use one or more of the policies 204, 208, and/or 212 to allow the cloud license manager service 202 to adopt its methods of license detach. In accordance with one embodiment, the system 200 performs a license automatic detach for all the new login requests according to the total workload of service comparing with a pre-defined throttling value according to the policy 204. For example, if all the existing requests have arrived to a 80% throttling value at a decision block 206, then the following login request will trigger a license automatic detach for the new coming requests from clients in a first scenario (Scenario A).

For dedicated busy clients, if its workload (how many requests per minutes or hours, etc. 60 times per minutes) has reached to client specific throttling under a second policy 208, then the Cloud License Manager Service 202 will detach the license to this client with long expiration period at decision block 210. The following requests will be denied with a dedicated error code. The busy client in this instance can retry to use the local detached license based on this dedicated error code under the second policy 208 (Scenario B).

For predictable busy clients under a third policy 212, the cloud license manager service 202 can pre-generate a detached license for a predicted peak time for certain clients according to historical data at decision block 214. Usually, the detached license generation is a time-consuming action, but the cloud license manager service 202 can generate the detached license in advance during an idle time for some clients with fixed busy time usage windows. For example, if a particular predicable busy client that usually begins office hours from 8:30 am to 9:30 am using licensed software such as a common email application like outlook, it can be launched concurrently. In existing systems, the requests will come to a Cloud License Manager and overwhelmed the system with requests. Instead, the system 200 and cloud license manager service 202 in accordance with the embodiments can use Policy 212 based on historical data to pre-generate detached license with random time (jitter) expiration period. (See FIG. 1, Scenario C and FIG. 2: Policy 3).

If client requests do not abide by the policies respective policies (204, 208, or 212), the Cloud License Manager Service 202 will actively synchronize the clients with an increased random time (jitter) heart beat duration along with increasing workload in each instance to reduce the client requests.

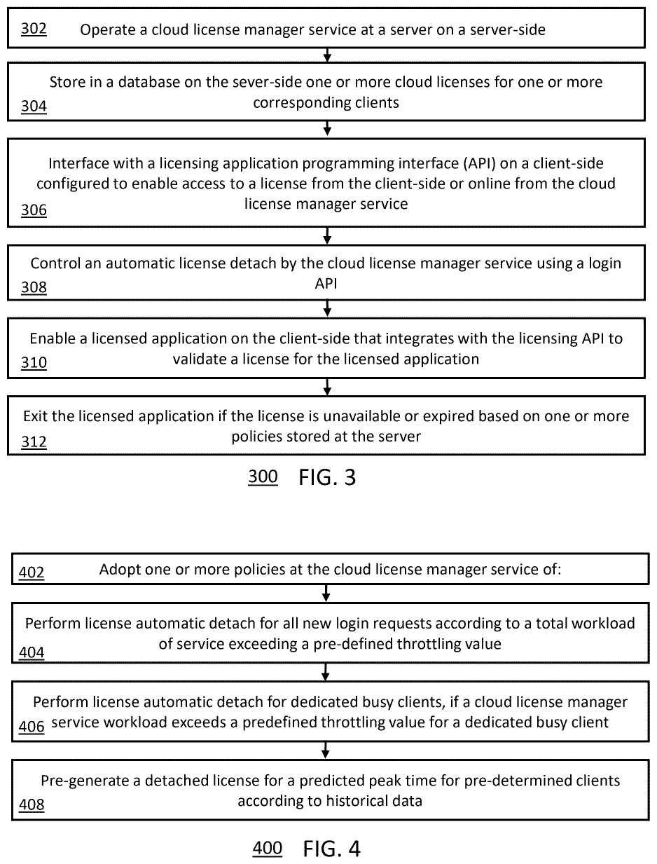

Referring to FIG. 3, in some embodiments a method 300 of smart license automatic detach by a cloud license manager service can include the operations of operating a cloud license manager service at a server on a server-side at step 302, storing in a database on the sever-side at step 304 one or more cloud licenses for one or more corresponding clients, and interfacing at step 306 with a licensing application programming interface (API) on a client-side configured to enable access to a license from the client-side or online from the cloud license manager service. The method 300 can further include the step 308 of controlling an automatic license detach by the cloud license manager service using a login API. In some embodiments, the method 300 can further include the step 310 of enabling a licensed application on the client-side that integrates with the licensing API to validate a license for the licensed application and exiting at step 312 the licensed application if the license is unavailable or expired based on one or more policies stored at the server.

Referring to a method 400 of FIG. 4, in order to perform the license detach (which can be a continuation of method 300 of FIG. 3), the cloud license manager service can also adopt one or more policies at 402. The policies at 402 can be one or more of (a) performing license automatic detach for all new login requests according to a total workload of service exceeding a pre-defined throttling value at 404; and/or (b) performing license automatic detach for dedicated busy clients, if a cloud license manager service workload exceeds a predefined throttling value for a dedicated busy client at 406; and/or (c) pre-generating a detached license for a predicted peak time for pre-determined clients according to historical data at 408.

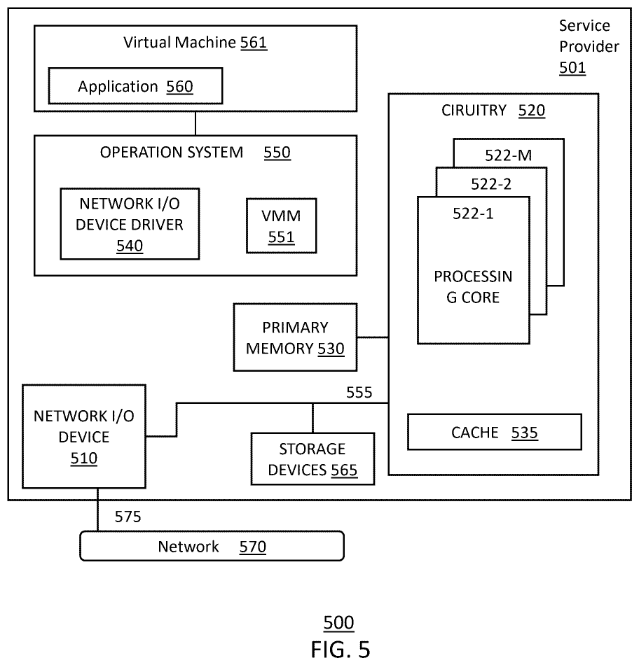

According to some examples, service provider 501, as shown in FIG. 5, includes circuitry 520, primary memory 530, operating system (OS) 550, Network (NW) I/O device driver 540, virtual machine manager (VMM) (also known as a hypervisor) 551, at least one application 560 running in a virtual machine (VM) 561, and one or more storage devices 565. In one embodiment, OS 550 is Linux™. In another embodiment, OS 550 is Windows® Server. Other OSs may also be used. In an embodiment, application 560 comprises one or more of a cloud license manager service having one or more smart license automatic detach policies. Network I/O device driver 540 operates to initialize and manage I/O requests performed by network I/O device 510. In an embodiment, packets and/or packet metadata transmitted to network I/O device 510 and/or received from network I/O device 510 are stored in one or more of primary memory 530 and/or storage devices 565.

In at least one embodiment, storage devices 565 may be one or more of hard disk drives (HDDs) and/or solid-state drives (SSDs). In an embodiment, storage devices 565 may be non-volatile memories (NVMs). In some examples, as shown in FIG. 5, circuitry 520 may communicatively couple to network I/O device 510 via communications link 555. In one embodiment, communications link 555 is a peripheral component interface express (PCIe) bus conforming to version 3.0 or other versions of the PCIe standard published by the PCI Special Interest Group (PCI-SIG).

In some examples, operating system 550, network I/O device driver 540, VM 561, and application 560 are implemented, at least in part, via cooperation between one or more memory devices included in primary memory 530 (e.g., volatile or non-volatile memory devices), storage devices 565, and elements of circuitry 520 such as processing cores 522-1 to 522-m, where “m” is any positive whole integer greater than 2. In an embodiment, OS 550, VMM 551, network I/O device driver 540, VM 561 and application 560 are executed by one or more processing cores 522-1 to 522-m.

In some examples, service provider 501, includes but is not limited to a server, a server array or server farm, a web server, a network server, an Internet server, a work station, a mini-computer, a main frame computer, a supercomputer, a network appliance, a web appliance, a distributed computing system, multiprocessor systems, processor-based systems, a laptop computer, a tablet computer, a smartphone, a system-on-a-chip (SoC), or a combination thereof. In one example, service provider 501 is a disaggregated server. A disaggregated server is a server that breaks up components and resources into subsystems (e.g., network sleds). Disaggregated servers can be adapted to changing storage or compute loads as needed without replacing or disrupting an entire server for an extended period of time. A server could, for example, be broken into modular compute, I/O, power and storage modules that can be shared among other nearby servers.

Circuitry 520 having processing cores 522-1 to 522-m may include various commercially available processors, including without limitation Intel® Atom®, Celeron®, Core (2) Duo®, Core i3, Core i5, Core i7, Itanium®, Pentium®, Xeon® or Xeon Phi® processors, ARM processors, and similar processors. Circuitry 520 may include at least one cache 535 to store data.

According to some examples, primary memory 530 may be composed of one or more memory devices or dies which may include various types of volatile and/or non-volatile memory. Volatile types of memory may include, but are not limited to, dynamic random-access memory (DRAM), static random-access memory (SRAM), thyristor RAM (TRAM) or zero-capacitor RAM (ZRAIVI). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magneto-resistive random-access memory (MRAM) that incorporates memristor technology, spin transfer torque MRAM (STT-MRAM), or a combination of any of the above. In another embodiment, primary memory 530 may include one or more hard disk drives within and/or accessible by service provider 501.

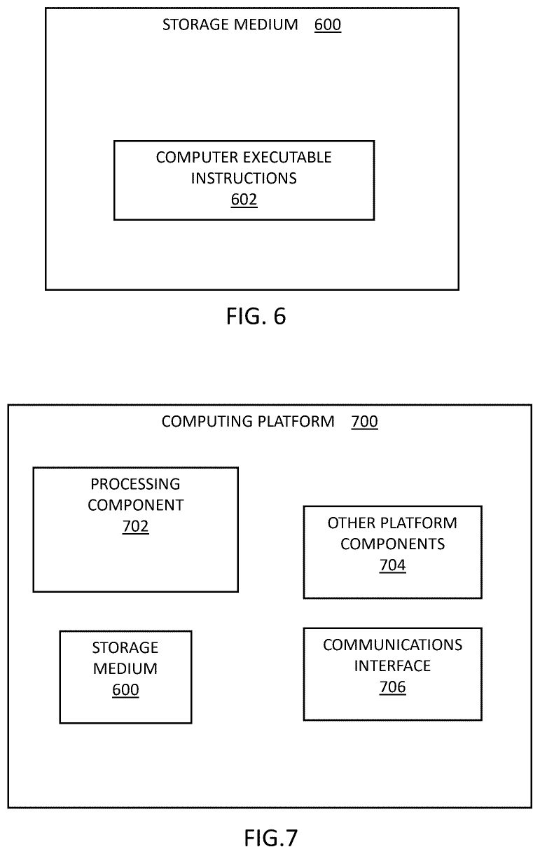

FIG. 6 illustrates an example of a storage medium 600. Storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions 602 to implement logic flows described above in FIGS. 1 through 4. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 7 illustrates an example computing platform 700. In some examples, as shown in FIG. 7, computing platform 700 may include a processing component 702, other platform components 704 and/or a communications interface 706.

According to some examples, processing component 702 may execute processing operations or logic for instructions stored on storage medium 600. Processing component 702 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 704 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that may be byte or block addressable. Non-volatile types of memory may also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine-readable storage media may also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 706 may include logic and/or features to support a communication interface. For these examples, communications interface 706 may include one or more communication interfaces that operate according to various communication protocols or standards to communicate over direct or network communication links or channels. Direct communications may occur via use of communication protocols or standards described in one or more industry standards (including progenies and variants) such as those associated with the peripheral component interconnect express (PCIe) specification. Network communications may occur via use of communication protocols or standards such those described in one or more Ethernet standards promulgated by the Institute of Electrical and Electronics Engineers (IEEE). For example, one such Ethernet standard may include IEEE 802.3. Network communication may also occur according to one or more OpenFlow specifications such as the OpenFlow Switch Specification.

The components and features of computing platform 700, including logic represented by the instructions stored on storage medium 600 may be implemented using any combination of discrete circuitry, ASICs, logic gates and/or single chip architectures. Further, the features of computing platform 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASIC, programmable logic devices (PLD), digital signal processors (DSP), FPGA, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Included herein are logic flows or schemes representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow or scheme may be implemented in software, firmware, and/or hardware. In software and firmware embodiments, a logic flow or scheme may be implemented by computer executable instructions stored on at least one non-transitory computer readable medium or machine readable medium, such as an optical, magnetic or semiconductor storage. The embodiments are not limited in this context.

Some examples are described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In the absence of any specific clarification related to its express use in a particular context, where the terms “substantial ” or “about ” or “usually” in any grammatical form are used as modifiers in the present disclosure and any appended claims (e.g., to modify a structure, a dimension, a measurement, or some other characteristic) , it is understood that the characteristic may vary by up to 30 percent.

The terms “include” and “comprise” as well as derivatives thereof, in all of their syntactic contexts, are to be construed without limitation in an open, inclusive sense, (e.g., “ including, but not limited to ”) . The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,“ are to be construed in an open, inclusive sense, e.g., ”including, but not limited to.”

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device or processor may be transformed from a generic and unspecific computing device or processor to a combination device comprising hardware and software configured for a specific and particular purpose providing more than conventional functions and solving a particular technical problem with a particular technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and Abstract of the Disclosure provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide further embodiments.

1. A system of smart license automatic detach by a cloud license manager service, comprising:
one or more processors and memory coupled to the one or more processors, wherein the memory includes computer instructions which when executed by the one or more processors causes the one or more processors to perform the operations of:
a cloud license manager service operating at a server on a server-side, wherein a database stores one or more cloud licenses for one or more corresponding clients;
a licensing application programming interface (API) on a client-side configured to access a license locally from the client-side or online from the cloud license manager service;
providing an automatic license detach executed by a login API and controlled by the cloud license manager service;
providing a licensed application on the client-side that integrates with the licensing API to validate a license for the licensed application; and
exiting the licensed application if the license is unavailable or expired based on one or more policies stored at the server.

2. The system of claim 1, wherein the API includes a credentialing function.

3. The system of claim 1, wherein the smart license automatic detach further provides a license detach based on workload and historical data available to the cloud license manager service.

4. The system of claim 1, wherein the cloud license manager service adopts a policy of performing license automatic detach for all new login requests according to a total workload of service exceeding a pre-defined throttling value.

5. The system of claim 4, wherein if a new login request exceeds an configurable predetermined throttling value, the new login request will trigger a license auto detach for the new login request.

6. The system of claim 1, wherein the cloud license manager service adopts the policy of performing license automatic detach for dedicated busy clients, if a cloud license manager service workload exceeds a predefined throttling value for a dedicated busy client.

7. The system of claim 6, wherein if the cloud license manager service workload exceeds the predefined throttling value, the cloud license manager service sends the dedicated busy client a denial of service message and a dedicated error coded that is configured to grant the client access to a local detached license upon a retry.

8. The system of claim 1, wherein the cloud license manager service adopts a policy of pre-generating a detached license for a predicted peak time for pre-determined clients according to historical data.

9. The system of claim 8, wherein the pre-generated detached license is generated in advance during an idle time for the pre-determined clients with a fixed busy time usage window.

10. The system of claim 1, wherein in order to perform the license detach, the cloud license manager service adopts the policies of
(a) performing license automatic detach for all new login requests according to a total workload of service exceeding a pre-defined throttling value;
(b) performing license automatic detach for dedicated busy clients, if a cloud license manager service workload exceeds a predefined throttling value for a dedicated busy client; and
(c) pre-generating a detached license for a predicted peak time for pre-determined clients according to historical data.

11. The system of claim 10, wherein the cloud manager service is further configured to actively synchronize a client failing to meet the policies (a), (b), or (c) with an increased random time jitter heart beat duration as an increasing workload at the server is determined to reduce client requests.

12. A system of smart license automatic detach by a cloud license manager service, comprising:
one or more processors and memory coupled to the one or more processors, wherein the memory includes computer instructions which when executed by the one or more processors causes the one or more processors at the one or more servers to perform the operations of:
a cloud license manager service operating at a server on a server-side, wherein a database stores one or more cloud licenses for one or more corresponding clients;
interfacing with a licensing application programming interface (API) on a client-side configured to enable access of a license from the client-side or online from the cloud license manager service;
controlling an automatic license detach by the cloud license manager service using a login API;
enabling a licensed application on the client-side that integrates with the licensing API to validate a license for the licensed application; and
exiting the licensed application if the license is unavailable or expired based on one or more policies stored at the server.

13. The system of claim 12, wherein the one or more servers on the server-side is further configured to monitor a workload from a plurality of clients based on a throughput value of requests to the one or more servers.

14. The system of claim 12, wherein the smart license automatic detach further provides a license detach based on workload and historical data available to the cloud license manager service.

15. The system of claim 12, wherein the cloud license manager service adopts a policy of performing license automatic detach for all new login requests according to a total workload of service exceeding a pre-defined throttling value.

16. The system of claim 12, wherein the cloud license manager service adopts the policy of performing license automatic detach for dedicated busy clients, if a cloud license manager service workload exceeds a predefined throttling value for a dedicated busy client.

17. The system of claim 12, wherein the cloud license manager service adopts a policy of pre-generating a detached license for a predicted peak time for pre-determined clients according to historical data.

18. The system of claim 12, wherein in order to perform the license detach, the cloud license manager service adopts the policies of
(a) performing license automatic detach for all new login requests according to a total workload of service exceeding a pre-defined throttling value;
(b) performing license automatic detach for dedicated busy clients, if a cloud license manager service workload exceeds a predefined throttling value for a dedicated busy client; and
(c) pre-generating a detached license for a predicted peak time for pre-determined clients according to historical data.

19. The system of claim 18, wherein the cloud manager service is further configured to actively synchronize a client failing to meet the policies (a), (b), or (c) with an increased random time jitter heart beat duration as an increasing workload at the server is determined to reduce client requests.

20. A method of smart license automatic detach by a cloud license manager service, comprising:
one or more processors and memory coupled to the one or more processors, wherein the memory includes computer instructions which when executed by the one or more processors causes the one or more processors at the one or more servers to perform the operations of:
operating a cloud license manager service at a server on a server-side;
storing in a database on the sever-side one or more cloud licenses for one or more corresponding clients;
interfacing with a licensing application programming interface (API) on a client-side configured to enable access to a license from the client-side or online from the cloud license manager service;
controlling an automatic license detach by the cloud license manager service using a login API;
enabling a licensed application on the client-side that integrates with the licensing API to validate a license for the licensed application; and
exiting the licensed application if the license is unavailable or expired based on one or more policies stored at the server.
